(19) United States
(12) Patent Application Publication
(10) Pub. No.: US 2008/0077437 A1
(43) Pub. Date: Mar. 27, 2008

(54) Process and Method for Providing Incentives to Increase Vision-Therapy Performance

(75) Inventors: Navroze Mehta, Boca Raton, FL (US); Robert Doll, Boca Raton, FL (US); Sigrid Kenkel, Delray Beach, FL (US); David Furshpan, Boca Raton, FL (US); Michelle Boster, Boca Raton, FL (US)

Correspondence Address: BROMBERG & SUNSTEIN LLP, 125 SUMMER STREET, BOSTON, MA, 02110-1618, US

(73) Assignee: NOVAVISION, INC., Boca Raton, FL (US)

(21) Appl. No.: 11/782,379

(22) Filed: Jul. 24, 2007

Related U.S. Application Data
(60) Provisional application No. 60/833,033, filed on Jul. 25, 2006.

(51) Int. Cl. G06Q 50/00

(52) U.S. Cl. 705/2

(57) ABSTRACT

Systems and methods provide incentives to a stimulative visual therapy user performing computer based visual therapy. User compliance with a recommended schedule of visual therapy is recorded, reward points are provided to the user based on compliance, and the user is rewarded based on the number of accumulated reward points awarded to the user.

### CROSS REFERENCE TO RELATED APPLICATIONS

This patent application claims priority to U.S. Provisional Patent Application Ser. No. 60/833,033, filed Jul. 25, 2006, which is hereby incorporated by reference herein in its entirety.

### TECHNICAL FIELD

The present invention relates to processes and methods for providing incentives to modify the performance of patients or of other users during sensory system therapy.

### BACKGROUND

Stimulating the vision system of human subjects with vision impairment may improve their visual performance. For example, as disclosed in U.S. Pat. No. 6,464,356, and US Published Patent Application No. 2005/0213033, which are hereby incorporated by reference herein in their entirety, presenting visual stimuli to areas of a human's visual system may allow improvement in the user's vision. NovaVision, of Boca Raton, Fla., produces VRT™ (Visual Restoration Therapy) devices for effecting optical stimulation of defined locations of a patient's retina. During a course of VRT, a finite number of stimulation events are available. Therefore, these stimulation events should be judiciously directed to the particular visual field regions for which treatment is desired.

VRT may be used to treat neurological deficits of the visual system of a patient. Such deficits may result from retinal damage, damage to the optic nerve or damage to the visual cortex, such as may occur due to stroke or traumatic brain injury. For example, age related macular degeneration (AMD) may be treated with VRT.

VRT therapy may be very demanding. For example, VRT may require two 30-minute sessions per day, 6 days per week, for 6-12 months. Because of such rigorous schedules, patient compliance may be problematic. Patients commonly skip sessions, days or weeks of therapy.

### SUMMARY OF THE INVENTION

However, visual system therapy requires dedication to performing the process. Thus, embodiments of the present invention are directed to methods of providing incentives to patients to perform visual system therapy, or to perform well in such therapy.

In an illustrative embodiment of the present invention, incentives are provided to a user (e.g., a patient, while the application to other users is described below) performing computer-based visual therapy, such as visual restoration therapy. The user's responses to visual stimuli are recorded during therapy. Based on those responses, reward points are provided to the user.

The reward may be automatically assigned to the user or the user may be allowed to redeem the reward points, either at a pre-determined time, or at a time chosen by the user. After redeeming reward points for a piece of the puzzle, the user is allowed to place one or more pieces of the puzzle together.

Based on the number of accumulated reward points, the user may be rewarded with one or more pieces of a puzzle. The particular puzzle from which the pieces are selected may be chosen by the user from a collection of one or more puzzles. After completing a puzzle scene, the user may be provided with an option of requesting a hardcopy of the puzzle scene.

In accordance with an illustrative embodiment of the present invention, there is a method of providing incentives to a stimulative visual therapy user performing computer based visual therapy. The method includes recording user compliance with a recommended schedule of visual therapy, providing reward points to the user based on compliance, and rewarding a user based on the number of accumulated reward points awarded to the user.

In a related embodiment the user may be rewarded by attributing one or more pieces of a puzzle to the user based on the number of accumulated reward points. The number of reward points may be tracked by updating a sum with reward points awarded to the user. The user may select a puzzle from one or more puzzles. Rewarding the user may include allowing the user to redeem reward points for one or more pieces of a puzzle; and allowing the user to place the one or more pieces of a puzzle together. After the puzzle scene is completed, the user may be given the option of requesting a tangible reward. Examples of tangible rewards include a hardcopy of the puzzle scene, an engraved copy of the puzzle scene, and a framed copy of the puzzle scene.

In another related embodiment, the reward is a tangible reward, which may be, for example, frequent flyer mileage points, store discount points or a gift card.

In another embodiment of the present invention, there is a computer program product for use on a computer system for providing incentives to a visual therapy user performing computer-based visual therapy. The computer program includes a computer usable medium having computer readable program code thereon. The computer readable program code includes program code for recording user compliance with a recommended schedule of visual therapy and program code for providing reward points to the user based on the responses.

The computer program product may include program code for rewarding the user with one or more pieces of a puzzle based on the number of accumulated reward points. The visual therapy may include VRT. The product may include program code for emitting spoken communications adapted based on a number of reward points issued to the user.

### BRIEF DESCRIPTION OF THE DRAWINGS

The foregoing features of the invention will be more readily understood by reference to the following detailed description, taken with reference to the accompanying drawings, in which:

FIG. 1 shows a puzzle scene divided into puzzle pieces;

FIG. 2 is a flow chart showing a method of fostering user performance according to an embodiment the present invention;

FIG. 3 is a flow chart showing a method of assigning reward points in accordance with an embodiment of the invention;

FIG. 4 shows a network for remotely monitoring patient compliance in accordance with an embodiment of the invention.

### DETAILED DESCRIPTION OF SPECIFIC EMBODIMENTS

Definitions. As used in this description and the accompanying claims, the following terms shall have the meanings indicated, unless the context otherwise requires:

A “puzzle scene” is an image that may be divided into several computer-displayable pieces to form a puzzle.

A “special piece” is one or more pieces of the puzzle that have not been placed into the puzzle scene.

As used herein, a “schedule” of stimulative visual therapy shall mean one or more recommended stimulative visual therapy sessions.

Illustrative embodiments of the present invention generally relate to a process and device for fostering a user's participation or performance in a therapeutic procedure to improve a human's vision. The therapeutic procedure may include presentation of optical stimuli that are allocated and directed to specific regions of the patient's visual field that are deemed to have high potential to induce recovery. In many cases, presentation of optical stimuli to an impaired visual system may allow recovery of visual-system performance. Embodiments of the invention may be used prophylactically for maintenance of visual systems.

In some embodiments, the present invention includes systems and methods for providing incentives to users performing vision therapy. The methods may be performed on any suitable VRT device, or in combination with therapeutic methods such as, for example, the devices and methods disclosed in U.S. Pat. No. 6,464,356 (hereby incorporated herein by reference), as well as co-pending U.S. patent applications, all of which are hereby incorporated herein by reference:
application Ser. No. 10/503,869, attorney docket number 2890/102, filed August, 2004;
application Ser. No. 11/153,250, attorney docket number 2890/105, filed Jun. 29, 2007;
application Ser. No. 11/343,960, attorney docket number 2890/107, filed Jan. 31, 2006;
application Ser. No. 11/640,548, attorney docket number 2890/116, filed Dec. 18, 2006;
application Ser. No. 11/394,154, attorney docket number 2890/111, filed Mar. 30, 2006;
application Ser. No. 11/771,293, attorney docket 2890/120, filed Jun. 29, 2007;
application Ser. No. 60/867,499, attorney docket 2890/114, filed Nov. 28, 2006;
application Ser. No. 11/669,783, attorney docket 2890/117, filed Jan. 31, 2007;
application Ser. No. 11/689,230, attorney docket 2890/119, filed Mar. 21, 2007.

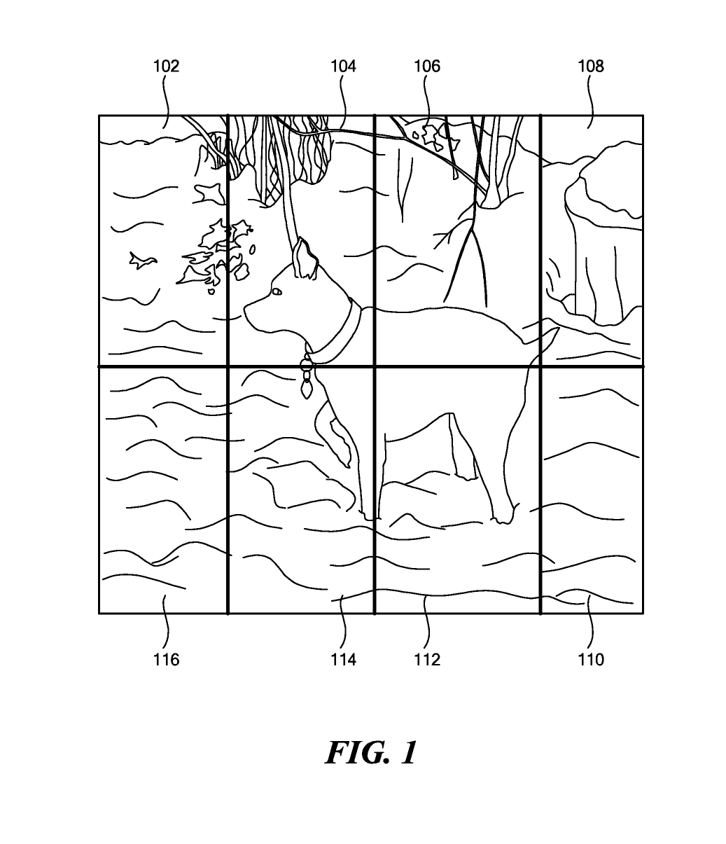

A puzzle screen 100 is shown in FIG. 1. As shown, the puzzle scene is divided into 8 pieces, 102, 104, 106, 108, 110, 112, 114, and 116, but that is by way of example only. The puzzle scene could be divided into any number of sections in any number of ways and the pieces could be of any shape. The puzzle scene may be selected from a collection of one or more possible puzzle scenes. Embodiments of the invention include rewarding a user by displaying a special piece of the puzzle.

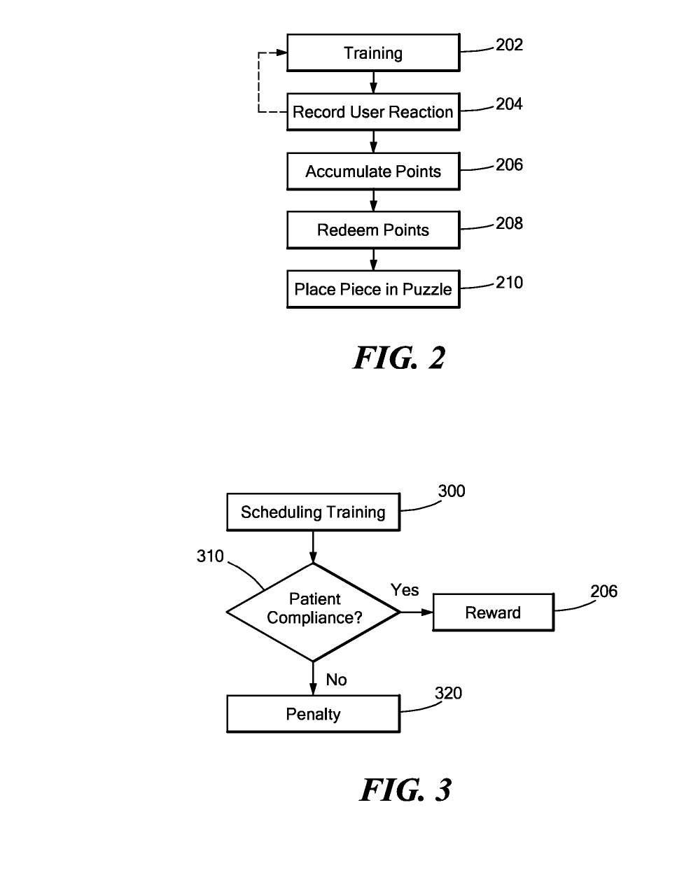

FIG. 2 shows a flow chart of a method for rewarding a user in accordance with an embodiment of the present invention. A user performs a vision therapy session in step 202 using a computer driven visual therapy device. User reactions are recorded (step 204) during step 202, and optionally, before therapy 202 in order to provide a baseline measurement. Examples of such reactions could include, but are not limited to: the user regularly performs vision therapy, the user completes a session, the user fixates properly, and the user has a low number of false-positive reactions. Reactions may be determined by providing a button or other input assembly on or associated with the visual therapy device that allows the user to respond when a particular stimulus is presented. The user reactions allow the user to accumulate points 206; the accumulated point total may recorded as an updated sum by the computer. The user may be rewarded based on the total points awarded to the user. For example. these points may be redeemed by the user to receive a special piece at step 208. However, the puzzle being illustrative only, other rewards may also be used. Redemption may be automatic, or upon the user's command. Redemption options may be provided to the user at pre-defined times or therapy milestones, or may be offered continuously. The piece may then be added to the puzzle scene in optional step 210. As another optional step, the user may be asked, if they would like to receive a tangible reward; for example, a hardcopy print of a puzzle after it is completed. The tangible reward may also be an engraved and/or framed and/or engraved puzzle image, trophy, plaque, frequent flyer mileage points, store discount points, gift card or other prize. The reward may include a personalized message of congratulations to the patient and may include the patient's name.

The specific puzzle scene used may be pre-determined, or may be selected by the user. Puzzle scenes or collections of puzzles scenes may be selected and presented to the user based on patient demographics. For example, children may be offered puzzle scenes of sports, or film characters, while more mature users may be offered puzzle scenes of beautiful vistas or classic artwork. Custom scenes may be also be used, for example, by uploading jpeg-format digital images.

FIG. 3 shows a method for encouraging patient compliance in accordance with an embodiment of the invention. First, a visual therapy schedule is established (step 300). Patient compliance is monitored, either locally, at a computer workstation, or remotely, via a networked computer. Reward points may be assigned to the patient (step 206) for one or more acts of patient compliance (e.g., beginning a therapy session, completing a session, responding to presented stimuli, correctly responding to presented stimuli, etc). The reward may be the addition of a special piece to a puzzle scene. Optionally, penalties may also be assigned for acts of non-compliance; for example, removing a puzzle piece from the scene for missing or unduly aborting a therapy session.

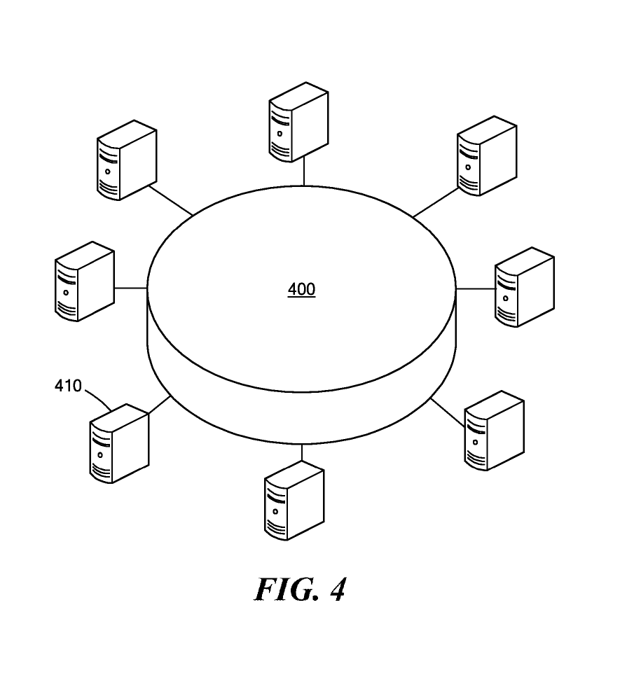

FIG. 4 shows a network for remotely monitoring patient compliance in accordance with an embodiment of the invention. A patient uses a local computer workstation 410 for VRT. A remote server 400 receives and records information related to patient compliance. Information related to a therapy schedule may be stored locally remotely, or both, and the therapy schedule may be compared to patient session logs to determine patient compliance. Patients, caregivers, guardians, supervisors, or other interested parties may be automatically informed of patient compliance metrics by the remote server. Such metrics may include, for example, the numbered of attended sessions, missed sessions, incomplete sessions, reward points, puzzle pieces, and puzzles completed. The method of notification may be, for example, email, or updating a networked html (hypertext markup language) document. Requests for tangible rewards may also be communicated via the network.

A visual therapy workstation 410 may emit audio instructions. For example, the workstation 410 may emit digitally recorded or computer generated verbal communications to the patient via a computer speaker. These communications may include instructions for proper set-up of the device, information regarding the commencement and termination of therapy, transmittal of therapy results, and the like.

Audible communications may also be used to foster a high level of patient participation and compliance. The audible communications may be selected or modified based on a patient's cumulative reward score. For example, if the reward scoring system shows that the patient has input very few false positive responses, the patient may be complimented with spoken positive reinforcement (e.g., “Good job!”). If the patient reward score or other measure of patient response shows problem areas, then the spoken instructions can be used to provide the patient with specific encouragement aimed at improving their compliance and performance with respect to these specific problem areas. Example of such specific problems, which my be indicative of a low level of patient concentration, include: a high number of false positive responses, too many prematurely aborted therapy sessions, a slow response time in responding to stimuli or fixation test cues.

The following are further examples of ways in which reward points may be accumulated. These examples are non-limiting and are presented only by way of explanation.

### EXAMPLE 1

In an embodiment of the invention, the reaction of the person to be trained upon the presentation of one or more stimuli is measured, and the performance of the person is rewarded. This may happen in a way that reward points are added to a “reward account” when the responses fulfill a predetermined criterion. For example, when the person to be trained is instructed to perform as quickly as possible, reward points are added to the reward account only in those cases where the response is recorded within a predetermined time delay (reaction time). Alternatively, reward points could be assigned to the reward account when a discrimination is properly made (e.g. correct form; color; or time discrimination of a stimulus). Reward points could also be provided for continuous therapy, completion of a given number of responses, or for maintaining visual fixation upon a target. Reward points may be provided automatically.

### EXAMPLE 2

In an embodiment of the invention, the number of reward points is used to automatically increase the difficulty of the next task. In this way, a way to increase the therapy difficulty is provided, depending upon the recordation of the reaction/response shown by the person to be trained. Depending upon the performance of the trained person in processing the presented optical stimuli by the visual system, the intact visual zone may be newly defined. Due to the therapy of the defined intact visual zone, vision in the intact visual zone may be improved. For example, therapy may improve a function of the visual system (e.g. peripheral vision, visual acuity, ability to discriminate between different colors, shapes, movement; reduction of squinting; increase of the visual angle), visual function in general, or help repair partial visual system injuries. As a result, the intact vision zone may be enlarged, or at least improved, with respect to its contribution to the person's vision. As found in practice, treated persons experienced an improvement of overall vision, as evidenced subjectively and by better performance in the therapy.

In alternative embodiments, the disclosed methods for fostering therapy may be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems.

Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

All aforementioned embodiments of the invention are intended to be merely exemplary and numerous variations and modifications will be apparent to those skilled in the art. All such variations and modifications are intended to be within the scope of the present invention as defined in the appended claims.

What is claimed is:

1. A method of providing incentives to a stimulative visual therapy user performing computer based visual therapy, the method comprising:
(a) recording user compliance with a recommended schedule of visual therapy;
(b) providing reward points to the user based on compliance; and
(c) rewarding a user based on the number of accumulated reward points awarded to the user.

2. A method according to claim 1, wherein rewarding the user further comprises attributing one or more pieces of a puzzle to the user based on the number of accumulated reward points.

3. A method in accordance with claim 1, further comprising updating a reward point sum.

4. A method in accordance with claim 1, wherein step (c) further comprises:
(d) allowing the user to redeem reward points for one or more pieces of a puzzle; and
(e) allowing the user to place the one or more pieces of a puzzle together.

5. A method in accordance with claim 1, further comprising:
allowing the user to select a puzzle from one or more puzzles.

6. A method in accordance with claim 1, further comprising:
providing the user the option of requesting a tangible reward after the puzzle scene is completed.

7. A method in accordance with claim 6, wherein the tangible reward is a copy of the puzzle scene.

8. A method in accordance with claim 6 comprises one of an engraving and a framed copy of the puzzle scene.

9. A method in accordance with claim 1, wherein rewarding the user comprises granting a tangible reward.

10. A method in accordance with claim 9, wherein the tangible reward is selected from the group consisting of frequent flyer mileage points, store discount points, and a gift card.

11. A computer system for visual therapy, the system comprising:
(a) means for recording user compliance related to a recommended schedule of visual therapy;
(b) means for compiling reward points to the user based on compliance with the scheduled therapy; and
(c) means for rewarding a user based on the compiled reward points

12. A computer system in accordance with claim 11, wherein rewarding the user further comprises providing the user with one or more pieces of a puzzle based on the number of accumulated reward points.

13. A system in accordance with claim 11 further comprising:
(d) means for allowing the user to redeem reward points for one or more pieces of a puzzle; and
(e) means for allowing the user to place the one or more pieces of a puzzle together.

14. A system in accordance with claim 11, further comprising means for allowing the user to select a puzzle from one or more puzzles.

15. A system in accordance with claim 11, further comprising means for providing the user the option of requesting a tangible reward.

16. A computer program product for use on a computer system for providing incentives to a visual therapy user performing computer-based visual therapy, the computer program product comprising a computer usable medium having computer readable program code thereon, the computer readable program code including:
(a) program code for recording user compliance with a recommended schedule of visual therapy; and
(b) program code for providing reward points to the user based on the responses.

17. A computer program product in accordance with claim 14, further comprising program code for rewarding the user with
one or more pieces of a puzzle based on the number of accumulated reward points.

18. A computer program product according to claim 16, wherein the visual therapy is VRT.

19. A computer program product according to claim 18 further comprising program code for emitting spoken communications adapted based on a number of reward points issued to the user.
